(19) United States
(12) Patent Application Publication
(10) Pub. No.: US 2009/0237094 A1
(43) Pub. Date: Sep. 24, 2009

(54) Method for evaluating magnetoresistive element

(75) Inventor: Tetsuya Takahashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/259,827

(22) Filed: Oct. 28, 2008

(30) Foreign Application Priority Data
Mar. 18, 2008 (JP) 2008-069160

(51) Int. Cl. G01N 27/04

(52) U.S. Cl. 324/693

(57) ABSTRACT

A method for evaluating a magnetoresistive element includes polarizing the magnetoresistive element in a first direction of a core width, and stepwise increasing a maximum magnetic field applied in a measurement and measuring a maximum value of resistance of the magnetoresistive element at each step. Measuring the maximum value includes applying a magnetic field in a second direction opposite to the first direction at each step and obtaining the maximum value of the resistance while changing the magnetic field from an initial magnetic field to the maximum magnetic field applied at each step.

### CROSS-REFERENCE TO RELATED APPLICATION

This application is based upon and claims the benefit of priority of the prior Japanese Patent Application No. 2008-069160, filed on Mar. 18, 2008, the entire contents of which are incorporated herein by reference.

### FIELD

The present invention relates to a method for evaluating magnetoresistive elements, which may be suitably used for a reproduction head provided in a hard disc drive.

### BACKGROUND

Conventionally, quasi-static testing (QST) is used as a method for measuring output characteristics of magnetoresistive elements as a function of the magnetic field applied thereto. Conventional QST measures the output characteristic of the magnetoresistive element by applying the magnetic field in a direction perpendicular to a direction in which hard films are biased while maintaining a state equivalent to a state in which the magnetic head (especially, reproduction element) is floated above a disc medium.

Recently, another method has been proposed to inspect some magnetic characteristics of the reproduction head or element that cannot be confirmed by the conventional QST (see Japanese Patent Application Publication No. 10-124825).

The method proposed in the above application applies the magnetic field to the biasing direction of the hard films, and measures the resistance value while gradually increasing or decreasing the magnetic field. The magnetoresistive element is inspected based on the measuring results.

However, the method proposed in the above-mentioned application may not measure the durability of the element accurately because of the following. The resistance value is measured while the magnetic field is gradually increased from an initial magnetic field level (for example, 0 [Gauss]) to a predetermined magnetic field level (for example, 3000 [Gauss]). A change in the characteristic (resistance value) involved in magnetic field levels (for example, 1000 [Gauss]) less than the predetermined magnetic field level (3000 [Gauss]) cannot be recognized when the magnetic field reaches the predetermined magnetic field level.

Further, only limited magnetic characteristics may be evaluated by using the measuring results obtained in the inspection method described in the aforementioned application. For example, it is difficult to evaluate the balance of ferromagnetic layers including the pin layer, the free layer and the hard films.

### SUMMARY

The present invention has been made in view of the above circumstance, and provides a more reliable method for evaluating a magnetoresistive element.

According to an aspect of the present invention, there is provided a method for evaluating a magnetoresistive element, the method including: polarizing the magnetoresistive element in a first direction of a core width; and stepwise increasing a maximum magnetic field applied in a measurement and measuring a maximum value of resistance of the magnetoresistive element at each step, measuring the maximum value including applying a magnetic field in a second direction opposite to the first direction at each step and obtaining the maximum value of the resistance while changing the magnetic field from an initial magnetic field to the maximum magnetic field applied at each step.

According to another aspect of the present invention, there is provided A method for evaluating a magnetoresistive element, the method including: polarizing the magnetoresistive element in a direction of a core width; applying an external magnetic field to the magnetoresistive element in a second direction opposite to the first direction and obtaining a first magnetic field applied at which a greatest resistance value is obtained; applying the external magnetic field to the magnetoresistive element in the first direction after polarizing the magnetoresistive element in the second direction; and obtaining a second magnetic field applied at which another greatest resistance value is obtained, evaluating a pined angle of pin layers of the magnetoresistive element and balance of ferromagnetic layers of the magnetoresistive element from the first and second magnetic fields.

### BRIEF DESCRIPTION OF THE DRAWINGS

FIG. 1 is a sectional view of a part of a magnetic head;

FIGS. 2A and 2B are respectively views of a magnetoresistive film and hard films;

FIGS. 3A and 3B are flowcharts of a sequence for evaluating a magnetic head in accordance with a first embodiment of the present invention;

FIG. 4 is a flowchart of the details of step S30;

FIGS. 5A through 5C depict the magnetized direction of a free layer and the magnetoresistive film obtained for different maximum magnetic fields applied in measurement;

FIGS. 6A through 6C depict the magnetized direction of the free layer and the magnetoresistive film obtained for further different (increased) maximum magnetic fields applied in measurement;

FIGS. 7A and 7B depict the magnetized direction of a free layer and the magnetoresistive film obtained for yet further different (increased) maximum magnetic fields applied in measurement;

FIG. 8 is a graph of the maximum and minimum values of the resistance measured at the respective steps depicted in FIGS. 5A through 5C, 6A through 6C, 7A and 7B;

FIG. 9 is a flowchart of a method for evaluating the magnetic head in accordance with a second embodiment of the present invention;

FIGS. 10A through 10D depict the magnetized direction of the free layer and the magnetoresistive film obtained for different maximum magnetic fields applied in measurement in the second embodiment;

FIGS. 11A through 11D depict the magnetized direction of the free layer and the magnetoresistive film obtained for further different (increased) maximum magnetic fields applied in measurement in the second embodiment;

FIG. 12 is a graph of the maximum and minimum values of the resistance measured at step S52 in FIG. 9;

FIG. 13 is a graph of the maximum and minimum values of the resistance measured at step S52 in FIG. 9 when the ferromagnetic layers are not balanced well;

FIGS. 14A and 14B are flowcharts of a sequence for evaluating the magnetic head in accordance with a third embodiment of the present invention; and

FIGS. 15A and 15B are graphs depicting a change of the resistance values obtained in the third embodiment.

### DESCRIPTION OF EMBODIMENTS

A description will now be given of embodiments of the present invention with reference to the accompanying drawings.

### First Embodiment

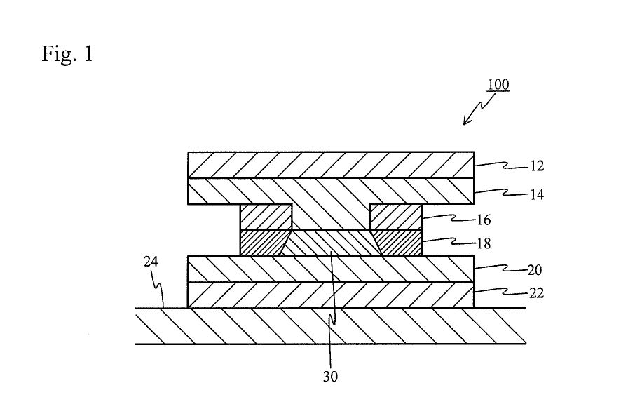

A first embodiment is described in conjunction with FIG. 1 through FIG. 8. FIG. 1 is a sectional view of a part of a magnetic head 100, which is an example of the magnetoresistive element to which an evaluating method according to the first embodiment is suitably applied.

The magnetic head 100 is a composite magnetic head having a recording part for recording information on a magnetic disc and a reproducing part for reproducing information therefrom. FIG. 1 illustrates only the reproducing part for the sake of simplicity. FIG. 1 is a sectional view of the reproducing part taken along a surface parallel to a main surface of the magnetic disc.

The magnetic head 100 is composed of a nonmagnetic substrate 24, a lower shield layer 22, a lower insulating layer 20, a magnetoresistive film 30, a pair of magnetic domain control layers (hard films) 18, a pair of electrodes 16, an upper insulating layer 14, and an upper shield layer 12. The recording head (not depicted) is formed on the upper shield layer 12. The lower shield layer 22 and the lower insulating layer 20 are stacked on the nonmagnetic substrate 24 in this order. The magnetoresistive film 30 is formed on the lower insulating layer 20. The pair of magnetic domain control layers 18 are formed so that the magnetoresistive film 30 are interposed therebetween from the opposing sides thereof. The pair of electrodes 16 are formed on the hard films 18. The upper insulating layer 14 is formed on the electrodes 16 and the upper side of the magnetoresistive film 30. The upper shield layer 12 is formed on the upper insulating layer 14.

The nonmagnetic substrate 24 may have a substrate made of aluminum oxide-titanium carbide (Al₂O₃—TiC) on which a silicon (Si) film or silicon oxide (SiO₂) film is formed. The lower shield layer 22 and the upper shield layer 12 may be layers made of a soft magnetic material such as FeN, and form magnetic shields that prevent an unwanted magnetic field from being applied to the magnetoresistive film 30. The lower insulating layer 20 and the upper insulating layer 14 may be made of an insulating substance such as aluminum (Al₂O₃), and prevent leakage currents from the magnetoresistive film 30, the hard films 18 and the electrodes 16. The hard films 18 may be a layer made of a material indicating hard magnetism, which may be Co—Pt alloy or Co—Cr—Pt alloy, and is used to apply a static magnetic field and a bias magnetic field based on exchange interaction.

The electrodes 16 may be an electrically conductive multilayer such as Ta/(Ti—W)/Ta, in which the Ti—W alloy layer is sandwiched between the two Ta layers, and is used to apply a sense current to the magnetoresistive film 30 via the hard films 18. A reproduced signal is obtained via the pair of electrodes 16.

The magnetoresistive film 30 may be of a spin-valve type and is involved in the information reproducing function of the magnetic head 100. More specifically, the magnetoresistive film 30 has a resistance that is changed in response to the magnetic field generated from each magnetized 1-bit section on the magnetic disc. The above change in resistance changes the sense current applied to the magnetoresistive film 30 via the pair of electrodes 16. Thus, information recorded in the form of the magnetized direction in each 1-bit section can be obtained.

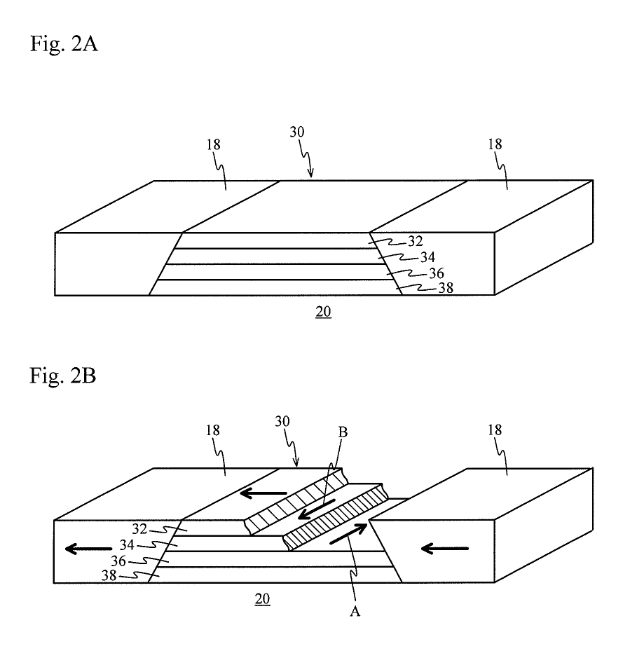

The structure of the magnetoresistive film 30 will now be described in detail with reference to FIGS. 2A and 2B. As depicted in FIG. 2A, the magnetoresistive film 30 includes an antiferromagnetic (AFM) layer 38 formed on the lower insulating layer 20, pin layers 36 and 34 formed on the antiferromagnetic layer 38 laminated in this order, and a free layer 32 formed on the pin layer 34. The antiferromagnetic layer 38 may be made of an antiferromagnetic material such as an Pd—Pt—Mn alloy. The antiferromagnetic layer 38 applies an exchange bias magnetic field due to exchange coupling to the pin layers 36 and 34.

The pin layers 36 and 34 are layers indicating soft magnetism. Although not illustrated in FIGS. 2A and 2B for the sake of simplicity, there is provided a pin coupling layer that is provided between the pin layers 36 and 34 and couples the magnetizations thereof in the opposite directions. The pin layers 36 and 34 may be made of an Co—Fe—B alloy. The magnetization of the pin layer 36 is pinned in a direction indicated by an arrow A due to the exchange bias magnetic field applied by the antiferromagnetic layer 38, as depicted in FIG. 2B. The magnetization of the pin layer 34 is pinned in a direction indicated by an arrow B opposite to that of the magnetization of the pin layer 36 due to the above-mentioned pin coupling layer (not depicted), as depicted in FIG. 2B. As described above, the present embodiment is arranged so that the magnetizations of the pin layers 36 and 34 are pinned in the opposite directions, so that the pin layers 36 and 34 have a small magnetization as a whole. Thus, the entire magnetization of the pin layers 36 and 34 is hardly affected by an external magnetic field, so that stable magnetization pinning can be realized and an antimagnetic field that affects the magnetic field carrying a signal from the magnetic disc can be restrained.

The free layer 32 may be made of a soft magnetic material such as a Co—Fe—B alloy, and the magnetization thereof is not pinned. Thus, the magnetization of the free layer 32 may be rotated in the plane thereof due to the magnetic field resulting from the magnetization of each 1-bit section. The sheet resistance of the magnetoresistive film 30 greatly changes in accordance with the angle formed by the magnetization of the free layer 32 and the pinned magnetization of the pin layers 36 and 34 due to so-called giant magnetoresistive. For example, the sheet resistance has a maximum value when the magnetization direction of the free layer 32 is opposite to that of the pin layer 34, and has a minimum value when the magnetization direction of the free layer 32 is identical to that of the pin layer 34.

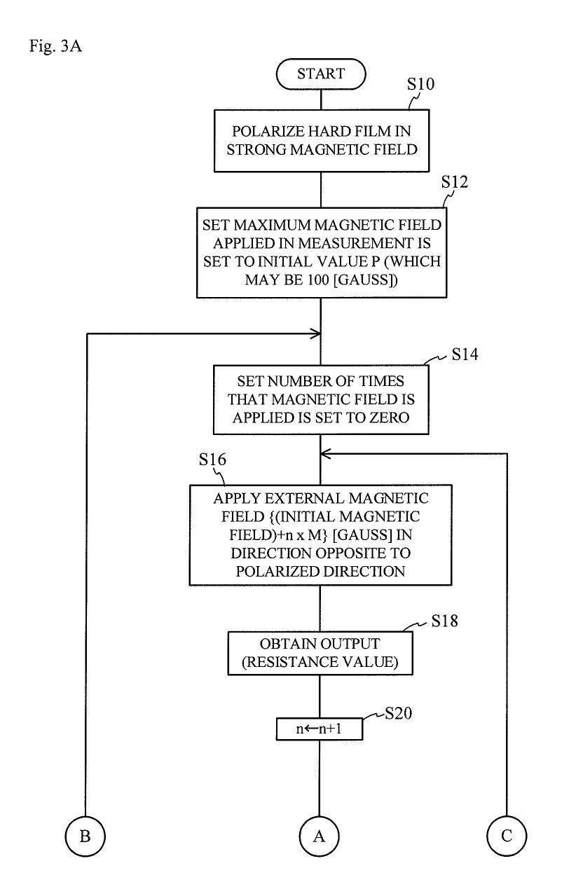

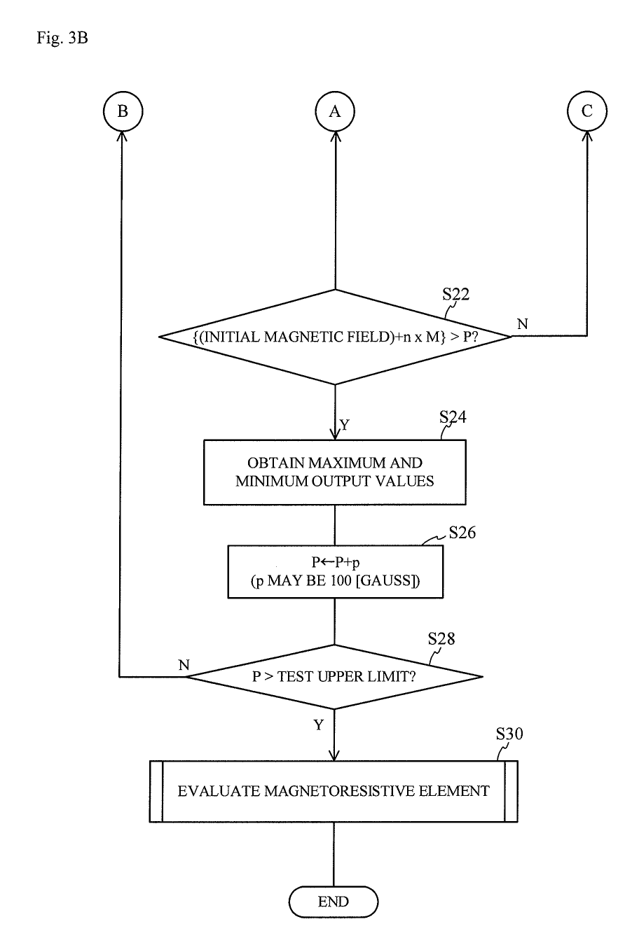

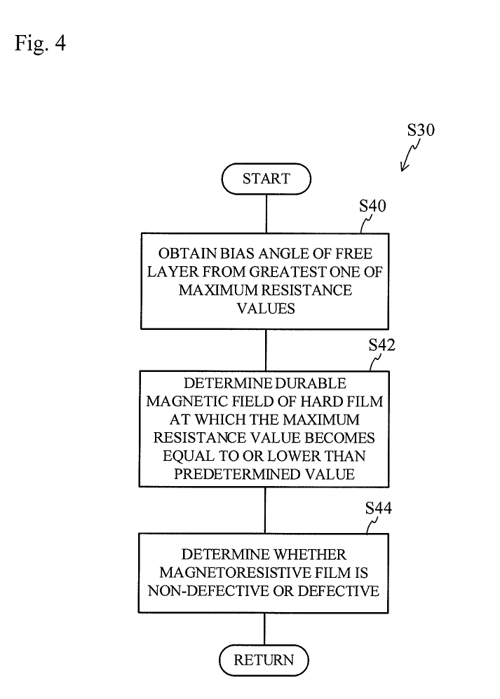

A description will now be given, with reference to flowcharts of FIGS. 3 and 4, of a method for evaluating the above-described magnetic head 100. The method may be implemented by an evaluating apparatus (head magnetic characteristics evaluating apparatus) capable of applying an arbitrary external magnetic field to the magnetic head 100 and detecting the resistance value of the magnetoresistive film 30 with the external magnetic field being applied.

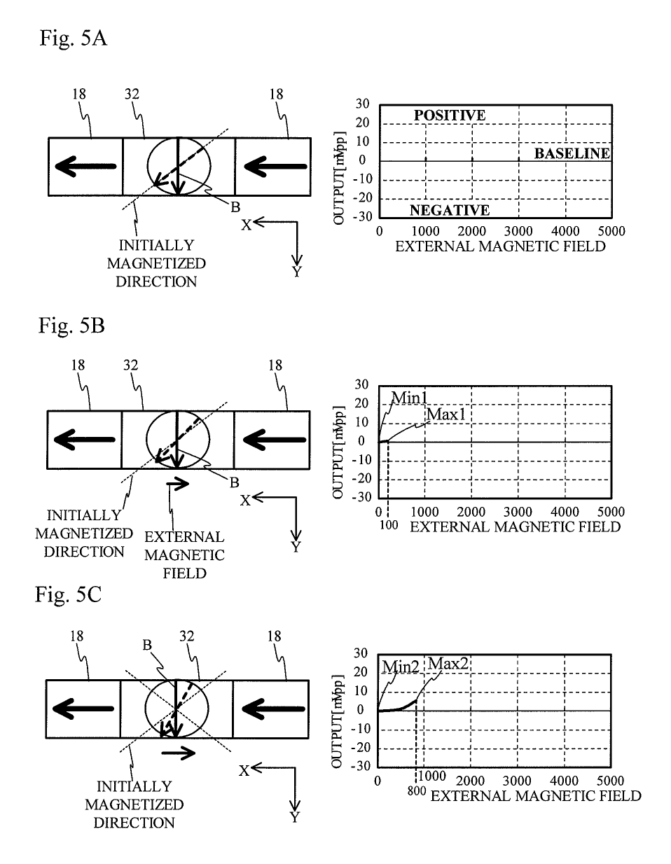

The method for evaluating the magnetic head 100 commences magnetically polarizing the hard films 18 with a magnetic field (as strong as, for example, 3000 [Gauss]) at step S10 depicted in FIG. 3A. In this case, it is assumed that, as depicted in a left part of FIG. 5A, the hard films 18 are polarized leftwards on the drawing sheet (+X direction), and the pin layer 34 is pinned in the direction indicated by the arrow B depicted in FIG. 2B (+Y direction in FIG. 5A). The magnetized direction of the free layer 32 (indicated by a broken line in FIG. 5A) is oriented in a direction crossing the X and Y axes in FIG. 5A due to the influence of magnetizations of the hard films 18 and the pin layer 34. In the following, the magnetized direction of the free layer 32 in FIG. 5A is called initially magnetized direction.

Next, the maximum magnetic field applied in the measurement is set to an initial value P at step S12. Now, it is assumed that the initial value P is set to 100 [Gauss]. Then, the number of times (n) that the magnetic field is repetitively applied is set to zero at step S14.

After that, an external magnetic field of {(initial magnetic field)+n×M} [Gauss] is applied in a direction (−X direction) opposite to the polarized direction of the hard films 18 at step S16. The initial magnetic field may, for example, be 0 [Gauss] or −5000 [Gauss]. In the following description, the initial magnetic field is 0 [Gauss]. Parameter “M” denotes an interval at which the external magnetic field is stepwise increased. For example, the parameter M may be 4 [Gauss]. In the graph of FIG. 5A, the resistance value in the state in which the free layer 32 is oriented in the initially magnetized direction is zero (described in BASELINE), and are described as POSITIVE and NEGATIVE for higher and lower resistance values, respectively.

Then, the output (resistance value) with the external magnetic field of {(initial magnetic field)+n×M} being applied is obtained at step S18. Thereafter, the counter (n) is incremented by 1 (n←n+1) at step S20, and the process proceeds to step S22.

At step S22, it is determined whether {(initial magnetic field)+n×M} [Gauss] is greater than the maximum magnetic field P that is set at step S12 (equal to 100 [Gauss]). Here, {(initial magnetic field)+n×M} [Gauss] is equal to 0+1×4)=4 [Gauss], and the determination result at step S22 is NO. Thus, the process returns to step S16.

After that, a sequence of steps S16, S18, S20 and S22 is repeatedly carried out until {(initial magnetic field)+n×M} [Gauss] exceeds the maximum magnetic field P applied in the measurement (equal to 100 [Gauss]). Thus, the resistance values are obtained while the external magnetic field is gradually increased at intervals of M [Gauss] (0→4→8→ . . . →100 [Gauss]). The resistance values thus obtained form a graph as depicted in FIG. 5B. In this case, as depicted in a left part of FIG. 5B, the magnetized direction of the free layer 32 merely becomes close to the +Y direction slightly even when the external magnetic field of 100 [Gauss] is applied. Thus, the resistance value merely increases gradually while the magnetized direction of the free layer 32 rotated in the counterclockwise direction, as depicted in the graph of FIG. 5B.

At step S24, the maximum value and the minim value of the output (resistance value) are obtained from the graph of FIG. 5B and stored. In FIG. 5B, the maximum value Max1 and the minimum value Min1(=0) on the graph are obtained.

Then, the maximum magnetic field P applied in the measurement is increased by “p” at step S26. It is now assumed that p has an exemplary value of 100 [Gauss]. At subsequent step S28, it is determined whether the maximum magnetic field P applied in the measurement exceeds a test upper limit (which may be 5000 [Gauss], for example). Here, P is only 200 [Gauss], and the determination result of step S28 is NO. Therefore, the process returns to step S14.

Then, a sequence of steps S14 through S28 is repeatedly carried out. The maximum magnetic field P applied in the measurement is stepwise increased (100→200→300→ . . . →4900→5000 [Gauss]), and the resistance value is measured in the range of the initially magnetized field (0 [Gauss]) to the respective maximum magnetic field applied in the measurement at each step. Then, the maximum value and the minimum values are extracted from the resistance values thus obtained. In this case, when the maximum magnetic field applied in the measurement is, for example, 800 [Gauss], as depicted in a left part of FIG. 5C, there is a midway step in which the magnetized direction of the free layer 32 is approaching the magnetized direction (indicated by the arrow B) of the pin layer 34. Thus, as illustrated in the graph of FIG. 5C, the resistance value continues to increase. It is now assumed that the maximum and minimum values in that case are denoted as Max2 and Min2 (=0), respectively.

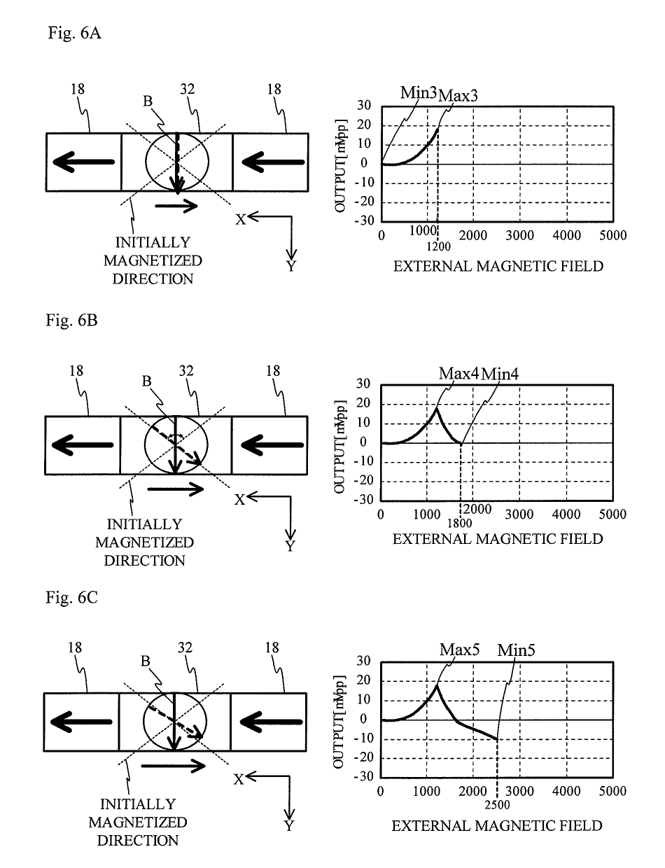

When the maximum magnetic field applied in the measurement is stepwise increased to 1200 [Gauss] from the initial magnetic field, as depicted in a left part of FIG. 6A, the magnetized direction of the free layer 32 almost coincides with the magnetized direction (arrow B) of the pin layer 34. Thus, as depicted in the graph of FIG. 6A, the resistance value reaches a level very close to the peak. It is now assumed that the maximum and minimum values in that case are Max3 and Min3 (=0), respectively.

When the maximum magnetic field applied in the measurement is 1800 [Gauss], as depicted in a left part of FIG. 6B, the magnetized direction of the free layer 32 goes beyond the magnetized direction of the pin layer 34 (indicated by the arrow B), and is oriented in a direction having a line symmetry with the initially magnetized direction of the pin layer 34 (having the same angle as that of the initially magnetized direction with regard to the magnetized direction of the pin layer 34). In this case, the resistance value is the same as that obtained in the initially magnetized direction, and is thus zero [Gauss]. Thus, when the maximum magnetic field applied in the measurement is 1800 [Gauss], as indicated by the graph of FIG. 6B, the resistance value increases as the external magnetic field increases from the initial magnetic field (0 [Gauss]), and reaches the peak for an external magnetic field of about 1200 [Gauss].

Then, the resistance value starts to decrease and becomes approximately equal to zero for an external magnetic field of about 1800 [Gauss]. It is now assumed that the maximum and minimum values in that case are Max4 and Min4 (=0), respectively.

In a case where the maximum magnetic field applied in the measurement is 2500 [Gauss], as depicted in a left part of FIG. 6C, the magnetized direction of the free layer 32 is rotated so as to become close to the −X direction from the direction symmetrical with the initially magnetized direction. Thus, the resistance value becomes smaller than that obtained in the initial state (shifts to the negative side). It is now assumed that the maximum and minimum values in that case are Max5 and Min5 (=0), respectively.

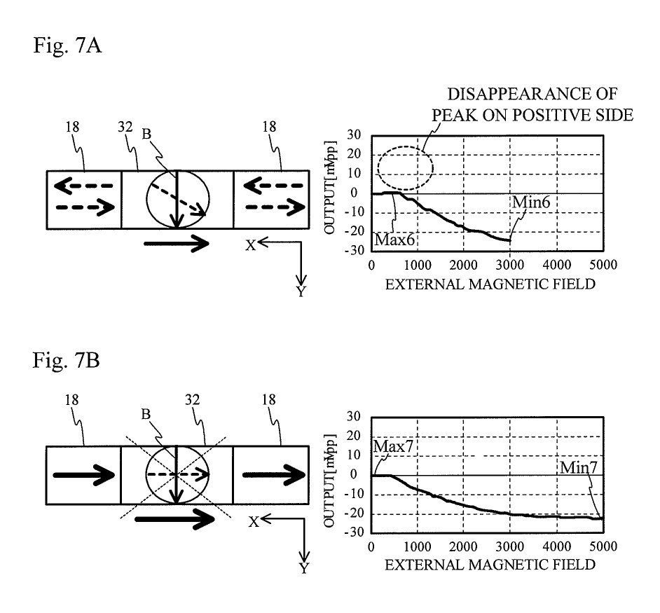

When the maximum magnetic field applied in the measurement becomes close to 3000 [Gauss], as illustrated in FIG. 7A, the external magnetic field having a strength approximately equal to that of the magnetic field of the hard films 18 is actually applied.

Thus, the magnetic field of the hard films 18 is degraded and does not work. In this case, the free layer 32 is pinned by the pin layer 34 (and does not rotate toward the +X direction beyond the angle depicted in FIG. 6B). Thus, as depicted in the graph of FIG. 7A, the resistance value is always negative even when the external magnetic field is increased from the initial magnetic field, and the peak on the positive side disappears. It is now assumed that the maximum and minimum values in that case are Max6 and Min6(=0), respectively.

When the maximum magnetic field applied in the measurement is increased over 3000 [Gauss], the hard films 18 is magnetically polarized in the same direction as that of the external magnetic field, as illustrated in FIG. 7B (the polarized direction is turned over). In this case, as the external magnetic field is increased, the free layer 32 becomes very close to the polarized direction (−Y direction) of the hard films 18. Thus, the resistance value is as depicted in FIG. 7B. It is now assumed that the maximum and minimum values in that case are Max7 and Min7 (−0), respectively.

The sequence of steps S14 through S28 is repeatedly carried out as described above. When the maximum magnetic field P applied in the measurement exceeds the test upper limit (which may be 5000 [Gauss], for example), the determination result of step S28 switches to YES, and the process proceeds to step S30.

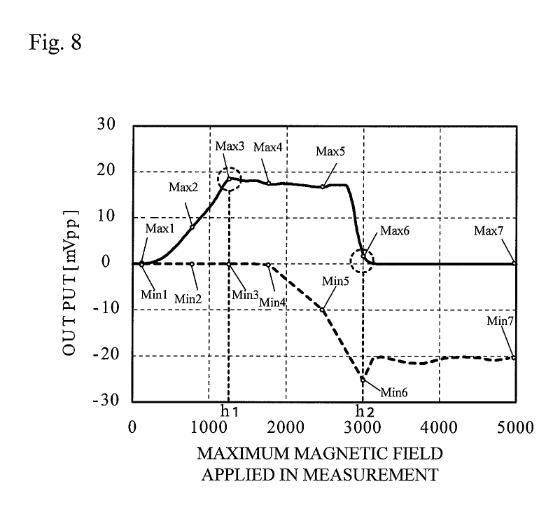

At step S30, a subroutine for evaluating the magnetoresistive film 30 (magnetic head 100) is executed with a graph of FIG. 8 is used in which the graph indicates the maximum and minimum values of the resistance obtained at step S24. The horizontal axis of the graph of FIG. 8 denotes the maximum magnetic field applied in measurement, and the vertical axis thereof denotes the resistance value.

At step S40 illustrated in FIG. 4, the peak of the change in the maximum resistance value, that is, the greatest one of the maximum resistance values, is obtained using the graph of FIG. 8. The maximum magnetic field h₁ indicating the greatest one of the maximum values is used to obtain the pin angle of the pin layer, that is, the bias angle of the free layer 32 (the angle between the initially magnetized angle and the magnetized direction of the pin layer 34). Here, the maximum magnetic field h₁ indicating the greatest one of the maximum resistance values is a particular maximum magnetic field applied in measurement for which the resistance having a tendency of increasing as the maximum magnetic field increases become the greatest. In FIG. 8, the maximum magnetic field h₁ is a magnetic field of 1200 [Gauss] corresponding to the maximum resistance value Max3.

At step S42, the graph of FIG. 8 is used to obtain a particular maximum magnetic field h₂ in which the maximum value of resistance becomes equal to or lower than a predetermined value after the maximum resistance value becomes the greatest and starts to decrease from an almost constant level. Further, in the particular maximum magnetic field h₂, the smallest one of the minimum resistance values is obtained. The maximum magnetic field h₂ applied in the measurement is defined as a durable magnetic field of the hard films 18. The above predetermined value may be zero or another value. In the present embodiment, the predetermined value is set slightly greater than zero because it is considered that the polarized direction of the hard films 18 is altered just before the maximum value of the resistance becomes zero (see FIG. 7A). In FIG. 8, the maximum magnetic field h₂ applied in the measurement is 3000 [Gauss].

At step S44, it is determined whether the magnetoresistive film 30 (magnetic head 100) is non-defective or defective by comparing the bias angle of the free layer 32 obtained at step S40 and the durable magnetic field of the hard films 18 obtained at step S42 with predetermined designed values (threshold values) of the magnetoresistive film 30.

Then, the subroutine ends, and the flowchart of FIGS. 3A and 3B thus ends.

As described above, the first embodiment has the sequence (steps S16 through S24) of applying the external magnetic field in the direction opposite to the polarized direction of the hard films 18 and obtaining the maximum values of the resistance while changing the external magnetic field from the initial magnetic field (0 [Gauss]) to the maximum magnetic field P applied in the measurement in such a manner that the maximum magnetic field P is changed stepwise (step S26) and is increased from the initial magnetic field at each step. It is thus possible to measure a change in the resistance value that cannot be measured by the conventional method in which the external magnetic field is gradually changed. More particularly, when the external magnetic field is gradually increased for obtaining the resistance value by the conventional method, it is not possible to recognize a change in the characteristic (resistance value) in the magnetic field that is caused when the external magnetic field has an intensity almost equal to the magnetic field of the hard films and that is smaller than the external magnetic field. The above change may be disappearance of the peak of the resistance value on the positive side in FIG. 7A. In contrast, according to the present embodiment, the maximum resistance value is measured while the magnetic field is changed or increased from the initial magnetic field (0 [Gauss]) to the respective maximum magnetic field at each step of the sequence. It is thus possible to recognize a change in the characteristic (disappearance of peak) and to appropriately evaluate the magnetoresistive film 30 (magnetic head 100) by using the change in the characteristic (evaluation of the resistance of the hard films 18 to the external magnetic field).

In the above description of the first embodiment, the greatest one of the maximum resistance values and the smallest one of the minimum resistance values are obtained to evaluate the bias angle of the free layer 32 and the durable magnetic field of the hard films 18. The above evaluation may be simplified by using only the greatest one of the maximum resistance values and the point at which the maximum value is zero, as depicted in FIG. 8. In this case, the minimum resistance value at each step is not needed. It is thus possible to reduce the amount of information to be processed.

In the above description of the first embodiment, the resistance value is measured each time the external magnetic field is stepwise increased from the initial magnetic field to the respective maximum magnetic field by M [Gauss] (which may be 4 [Gauss]). The first embodiment may be varied so that the external magnetic field is continuously increased from the initial magnetic field, and the resistance value is constantly monitored during the period when the external magnetic field is being increased. This makes it possible to more precisely obtain the resistance value.

### Second Embodiment

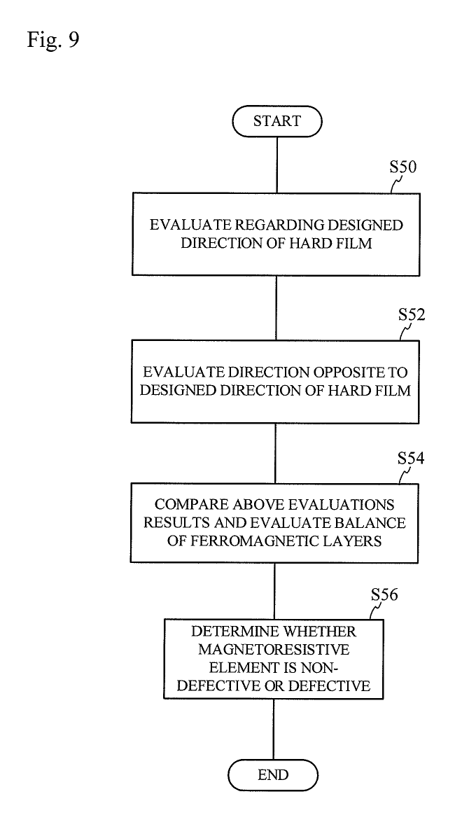

A description will now be given, with reference to FIGS. 9 through 13, of a second embodiment, which is directed to a different method for evaluating the magnetic head 100. The structure of the magnetic head 100 handled by the second embodiment is the same as that used in the first embodiment.

At step S50 depicted in FIG. 9, an evaluation regarding the designed direction of the hard films 18 is carried out. More specifically, the hard films 18 are evaluated with the hard films 18 being polarized in the designed direction (which is now assumed as the +X direction). This is carried out by measurement and evaluation similar to those of the first embodiment. More particularly, the resistance values are measured to obtain a graph similar to that depicted in FIG. 8, and the maximum magnetic fields h₁ and h₂ applied in the measurement are obtained therefrom for getting the bias angle of the free layer 32 and the durable magnetic field of the hard films 18.

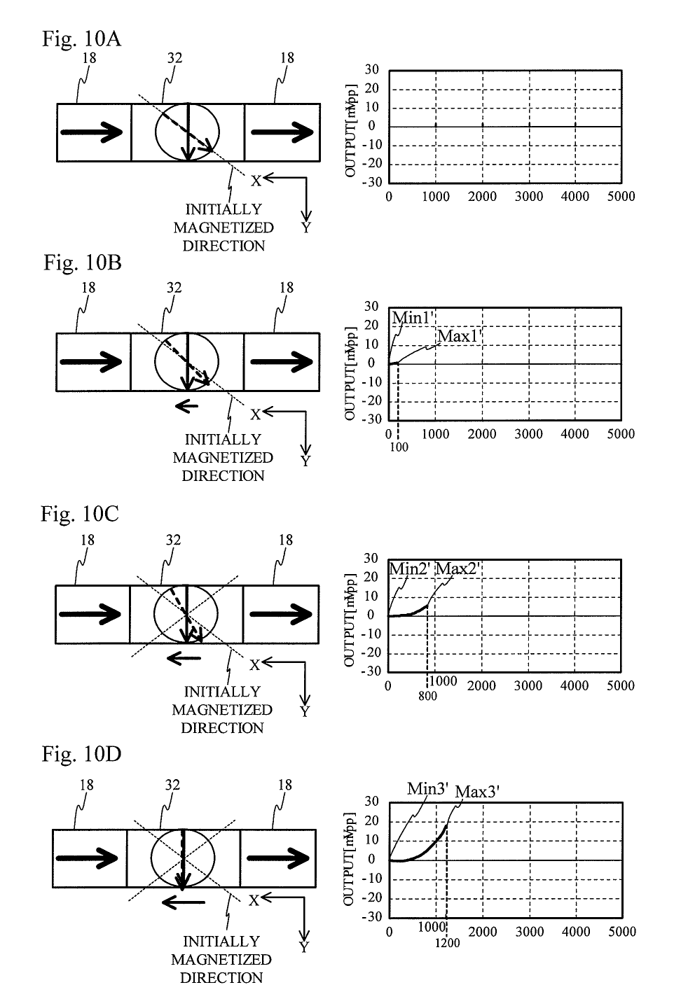

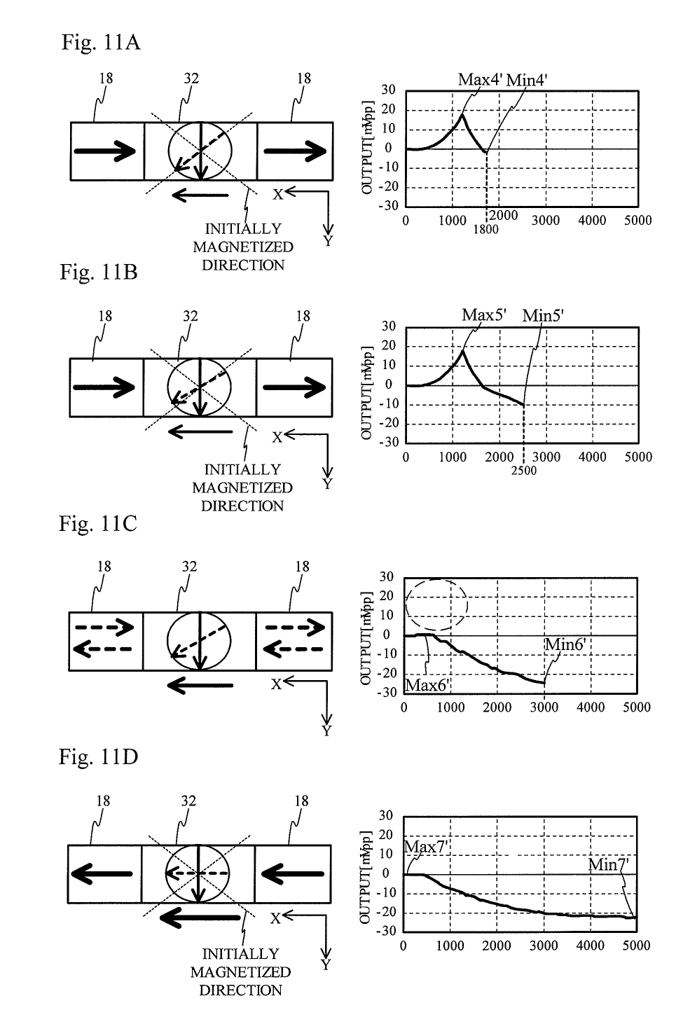

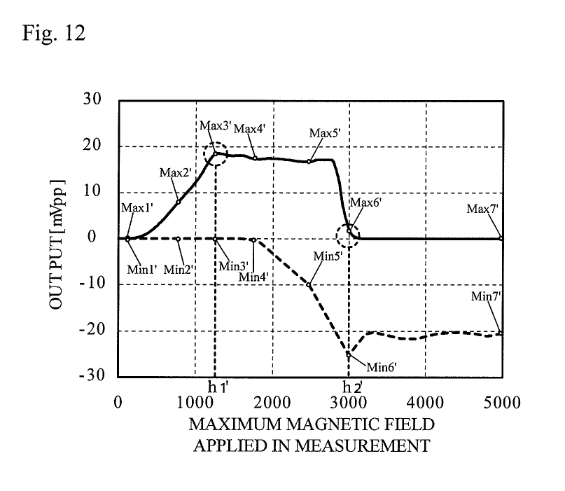

Next, at step S52, an evaluation regarding the opposite direction of the hard films 18 is carried out. More specifically, the hard films 18 are evaluated in a state where it is polarized in the direction (−X direction) opposite to the designed direction. Except that the hard films 18 is polarized in the opposite direction, the same measurement and evaluation as those of the first embodiment are carried out. More particularly, as illustrated in FIGS. 10A through 10D and FIGS. 11A through 11D, the hard films 18 are magnetically polarized in the −X direction. In this state, the maximum values (Max 1′-Max7′) and minimum values (Min1′-Min7′) of the resistance values are obtained while the external magnetic field is applied in the +X direction. Thus, a graph is obtained from the maximum and minimum values thus obtained. The maximum magnetic fields (h₁′, h₂′) applied in the measurement are obtained from the graph of FIG. 12, and are used to obtain the bias angle of the free layer 32 and the durable magnetic field of the hard films 18 regarding the opposite direction of the hard films 18.

At step S54 in FIG. 9, the evaluations at steps S50 and S52 are compared, and the degree of coincidence of the graph of FIG. 8 and that of FIG. 12 are evaluated. It can be said that the magnetized states of the pin layer 34, the free layer 32 and the hard films 18 are well balanced (in other words, the ferromagnetic layers are magnetically balanced well) when the bias angles of the free layer 32 obtained at steps S50 and S52 substantially coincide with each other and the durable magnetic fields of the hard films 18 obtained at steps S50 and S52 substantially coincide with each other (that is, when h₁=h₁′ and h₂=h₂′). A similar decision may be made when the graphs of FIGS. 9 and 12 substantially coincide with each other.

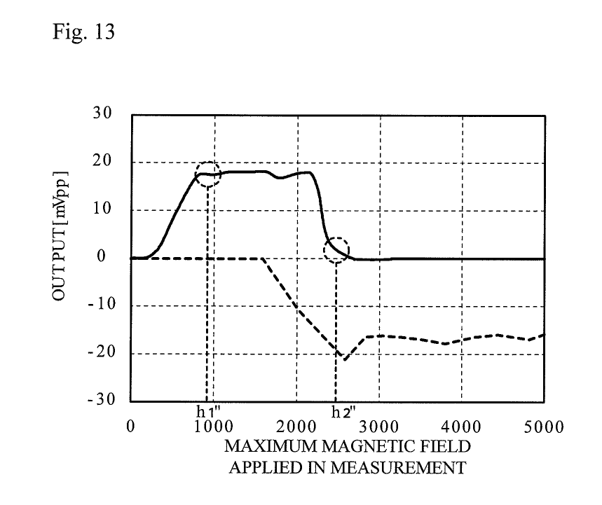

In contrast, it can be evaluated that the ferromagnetic layers are not balanced well in any of the following cases. An exemplary case is such that the bias angles of the free layer 32 obtained at steps S50 and S52 do not coincide with each other well or the durable magnetic fields of the hard films 18 obtained at steps S50 and S52 do not coincide with each other well (the degree of coincidence between h₁ and h₁′ is low or the degree of coincidence between h₂ and h₂′ is low). Another exemplary case is such that a graph as depicted in FIG. 13 is obtained in evaluation regarding the opposite direction of the hard films 18 and does not coincide with the graph of FIG. 8 well.

At subsequent step S56, it is determined whether the magnetoresistive film 30 (magnetic head 100) is non-defective or defective by using the comparison results regarding the bias angles of the free layer 32 and the durable magnetic fields of the hard films 18 (the degree of coincidence), evaluation of the balance of the ferromagnetic layers, and the predetermined designed values (threshold values) of the magnetoresistive film 30 (magnetic head 100).

As described above, according to the second embodiment, the evaluation similar to that of the first embodiment is performed regarding the designed direction of the hard films and the opposite direction thereof, and the evaluation results thus obtained are compared to evaluate the magnetoresistive film 30 (magnetic head 100). It is thus possible to appropriately evaluate the magnetoresistive film 30 (magnetic head 100) taking the balance of the ferromagnetic layers into consideration.

As described above, the second embodiment described above evaluates the balance of the ferromagnetic layers by using the degree of coincidence between the graphs obtained in the evaluations of the designed direction and opposite direction of the hard films 18, the results of the comparison between the bias angles of the free layer 32, and the results of the comparison between the durable magnetic fields of the hard films 18. The second embodiment may be varied so that only one of the above factors may be used to evaluate the balance of the ferromagnetic layers. For example, only the results of the comparison between the bias angles of the free layer 32 can be used to evaluate the balance of the ferromagnetic layers. More particularly, the magnetic fields h₁ and h₁′ are compared and the magnetic fields h₂ and h₂′ are compared by using the graphs of FIGS. 8 and 12 obtained from the results of steps S50 and S52 depicted in FIG. 9. Since the graphs of FIGS. 8 and 12 are very similar to each other, it can be evaluated that the balance of the ferromagnetic layers is good. In contrast, when the graphs of FIGS. 8 and 13 are obtained from the results of steps S50 and S52 depicted in FIG. 9, there is a considerable difference between the magnetic fields h₁ and h₁″ and there is also a considerable difference between the magnetic fields h₂ and h₂″, as compared to the graphs of FIGS. 8 and 12. It is thus evaluated that the ferromagnetic layers are not balanced well.

### Third Embodiment

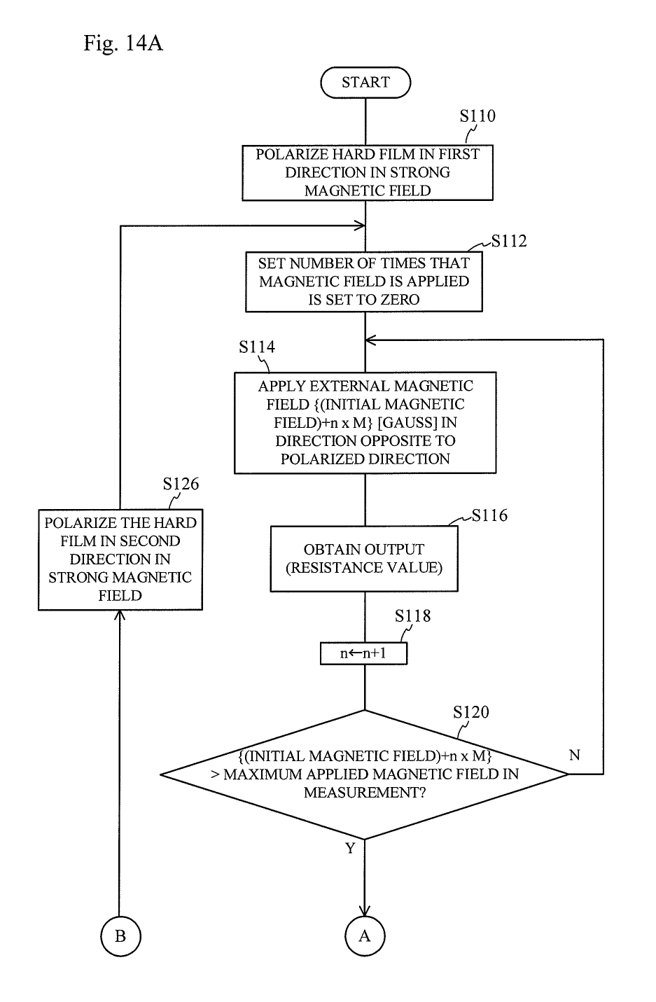

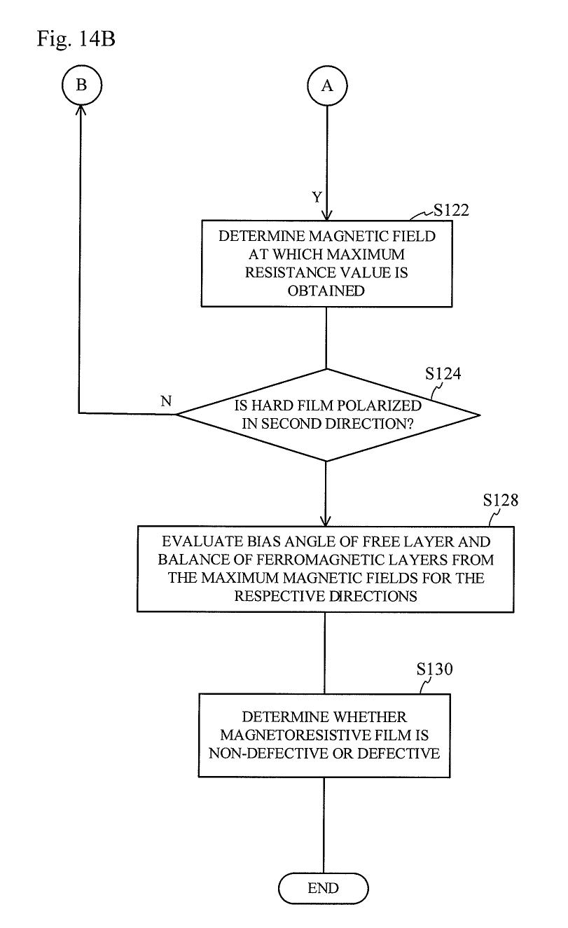

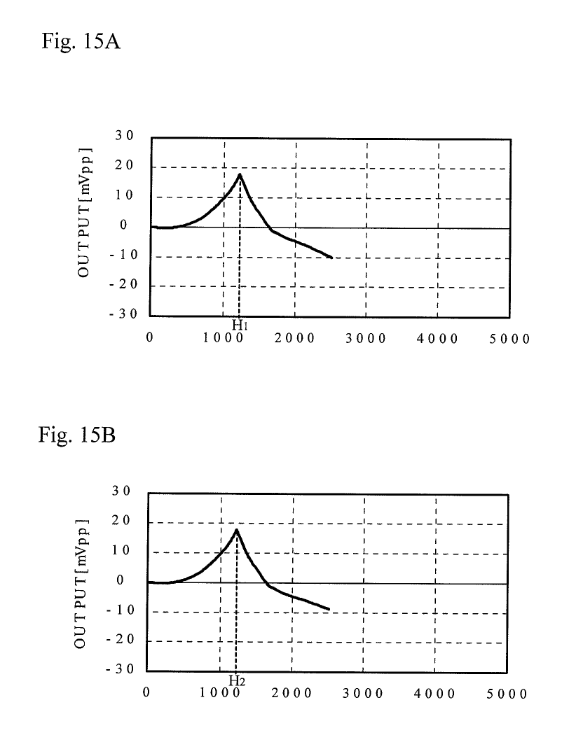

A third embodiment of the present invention will now be described with reference to FIGS. 14A, 14B and 15. The third embodiment is directed to a method for evaluating the magnetic head 100 like the second embodiment.

At step S110 depicted in FIG. 14A, the hard films 18 are polarized in a first direction (for example, the designed direction of the hard films (+X direction)) in a strong magnetic field. At step S112, the number of times that the magnetic field is applied is set equal to zero.

At step S14, the external magnetic field of {(initial magnetic field)+n×M} [Gauss] is applied in the direction opposite to the magnetically polarized direction. The initial magnetic field may be zero [Gauss] and M may be 4 [Gauss] as in the cases of the first and second embodiments. At subsequent step S116, the resistance value of the magnetoresistive film 30 with the external magnetic field being applied is obtained.

At step S118, the counter (n) is incremented by 1 (n←n+1). At subsequent step S120, it is determined whether the external magnetic field {(initial magnetic field)+n×M} exceeds the maximum magnetic field applied in the measurement. The maximum magnetic field may, for example, be 2500 [Gauss]. When the determination result of step S120 is NO, the process returns to step S114.

After that, the sequence of steps S114, S116, S118 and S120 is repeatedly carried out, so that the resistance values are obtained while the external magnetic field is increased at intervals of 4 [Gauss] until the determination result of step S120 becomes YES. Then, the process goes to step S122.

At step S122, a graph (FIG. 15A) of the resistance values obtained by repeatedly executing steps S114 through S120 is used to determine an external magnetic field H₁ (hereinafter referred to as first magnetic field) at which the resistance value becomes the greatest.

At step S124, it is determined whether the hard films 18 are polarized in a second direction (the direction opposite to the designed direction (—X direction)). Here, the hard films 18 has merely been polarized in the first direction, and the determination result of step 124 is NO. At subsequent step S126, the hard films 18 are polarized in the second direction in a strong magnetic field. At next step S112, the number of times that the magnetic field is applied is reset to zero.

After that, the sequence of steps S114 through S120 is repeatedly carried out. While the external magnetic field applied to the direction (first direction) opposite to the second direction is gradually increased, the resistance values and the resultant graph (see FIG. 15B) are obtained in the same manner as mentioned previously.

At step S122, an external magnetic field H₂ at which the resistance value becomes the greatest is determined on the basis of the graph of the resistance values depicted in FIG. 15B. At step S124, it is determined whether the hard films 18 are polarized in the second direction (the direction opposite to the designed direction). Since the hard films 18 have been polarized in the second direction at step S126, the determination result of step S126 is YES and the process goes to step S128.

At step S128 for evaluation, the bias angle of the free layer 32 is obtained from either one of the first magnetic field H₁ and the second magnetic field H₂. Further, H₁ and H₂ are compared with each other to determine the degree of coincidence for evaluating the balance of the ferromagnetic layers.

At subsequent step S130, it is determined whether the magnetoresistive film 30 (magnetoresistive head 100) is non-defective or defective on the basis of the evaluation results at step S128.

As described above, according to the third embodiment, the hard films 18 is polarized in the designed direction, and the magnetic field is then applied in the opposite direction to obtain the first magnetic field H₁ at which the measured resistance becomes the greatest. Then, the hard films 18 is polarized in the direction opposite to the designed direction, and the magnetic field is applied in the opposite direction to obtain the second magnetic field H₂ at which the measured resistance becomes the greatest. The magnetic fields H₁ and H₂ thus obtained are compared with each other to evaluate the bias angle of the free layer and the balance of the ferromagnetic layers. It is thus possible to appropriately evaluate the magnetoresistive film 30 (magnetic head 100) taking the polarized direction into account.

The third embodiment may be varied so that the balance of the ferromagnetic layers is evaluated by referring to the degree of coincidence between the entire graph of FIG. 15A and the entire graph of FIG. 15B. It is thus possible to more appropriately evaluate the balance of the ferromagnetic layers.

In the above description of the third embodiment, the external magnetic field is stepwise increased at intervals of M [Gauss] (4 [Gauss], for example) from the initial magnetic field, and the resistance value is obtained for every increase. Alternatively, the external magnetic field is continuously increased from the initial magnetic field, and the resistance value is constantly monitored during the period when the external magnetic field is being increased. This makes it possible to more precisely obtain the resistance value.

The numeral values described before such as the initial magnetic field, the maximum magnetic field P and the measurement intervals M are exemplary ones, and the present invention is not limited thereto.

The present invention is not limited to the specifically described embodiments and variations, and other embodiments and variations may be made without departing from the scope of the present invention.

1. A method for evaluating a magnetoresistive element, the method comprising:
polarizing the magnetoresistive element in a first direction of a core width; and
stepwise increasing a maximum magnetic field applied in a measurement and measuring a maximum value of resistance of the magnetoresistive element at each step, measuring the maximum value including applying a magnetic field in a second direction opposite to the first direction at each step and obtaining the maximum value of the resistance while changing the magnetic field from an initial magnetic field to the maximum magnetic field applied at each step.

2. The method according to claim 1, further comprising measuring a minimum value of the resistance of the magnetoresistive element at each step by applying the magnetic field in the second direction at each step and obtaining the minimum value of the resistance while changing the magnetic field from the initial magnetic field to the maximum magnetic field applied at each step.

3. The method as claimed in claim 1, further comprising evaluating a pined angle of pin layers of the magnetoresistive element and balance of ferromagnetic layers of the magnetoresistive element from a greatest one of the maximum values respectively obtained at the steps that tend to increase as the maximum magnetic field applied is increased.

4. The method as claimed in claim 1, further comprising evaluating a durable magnetic field of ferromagnetic layers of the magnetoresistive element from the maximum magnetic field applied at which a predetermined maximum value is obtained after a greatest one of the maximum values respectively obtained at the steps that tend to increase as the maximum magnetic field applied is increased.

5. The method as claimed in claim 2, further comprising evaluating a pined angle of pin layers of the magnetoresistive element and balance of ferromagnetic layers of the magnetoresistive element from a greatest one of the maximum values respectively obtained at the steps that tend to increase as the maximum magnetic field applied is increased.

6. The method as claimed in claim 2, further comprising evaluating a durable magnetic field of ferromagnetic layers of the magnetoresistive element from the maximum magnetic field applied at which a predetermined maximum value is obtained after a greatest one of the maximum values respectively obtained at the steps that tend to increase as the maximum magnetic field applied is increased.

7. A method for evaluating a magnetoresistive element, the method comprising:
polarizing the magnetoresistive element in a direction of a core width;
applying an external magnetic field to the magnetoresistive element in a second direction opposite to the first direction and obtaining a first magnetic field applied at which a greatest resistance value is obtained;
applying the external magnetic field to the magnetoresistive element in the first direction after polarizing the magnetoresistive element in the second direction; and
obtaining a second magnetic field applied at which another greatest resistance value is obtained,
evaluating a pined angle of pin layers of the magnetoresistive element and balance of ferromagnetic layers of the magnetoresistive element from the first and second magnetic fields.
